(19) United States
(12) Patent Application Publication
(10) Pub. No.: US 2004/0128400 A1
(43) Pub. Date: Jul. 1, 2004

(54) Method and apparatus for automated gathering of network data

(76) Inventors: Krishnamurthy Srinivasan, Chandler, AZ (US); Pallavi G. Malu, Scottsdale, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/334,808

(22) Filed: Dec. 31, 2002

(51) Int. Cl. G06F 15/173; G06F 15/16

(52) U.S. Cl. 709/250; 709/224; 709/246

(57) ABSTRACT

A method and apparatus for automated gathering of network data. A machine automated process generates a function for an application to access data from a network component. The function includes a network component interface to identify the types of the data and an application interface to supply the data in a compatible type for the application. The network component may provide meta-data to the network component interface, so that it can identify the types of the data. The function may also include a filter to identify when the data is in a compatible type and a filter to convert the data to compatible types for the application. The functions generated may take numerous forms, for instance, application user-defined functions, application macros or dynamic link libraries (DLLs). The network components may also be of a number of types, for instance, Java components, Component Object Model (COM) components or network services components.

### FIELD OF THE DISCLOSURE

This disclosure relates generally to the field of data processing. In particular, the disclosure relates to automated gathering of network data.

### BACKGROUND OF THE DISCLOSURE

Computer networking provides opportunities for sharing of data among businesses and individuals. Commonly used languages and application programmer interfaces (APIs) provide opportunities for network based services to facilitate the sharing of such data. Yet, gathering data from disparate sources and presenting the data in a context-sensitive fashion may involve considerable expertise and programming.

One way to make use of data from networked services or data sources is through personal productivity tools—data bases or spread sheets for example. An experienced user may manually search relevant data, then copy and paste such data into the appropriate productivity tool. For an application requiring extensive amounts of data or requiring data from any large number of sources, a manual approach may be quite time consuming and labor intensive.

Alternatively, custom data containers may be programmed by more advanced users having: an understanding of the programmable capabilities of the productivity tool for connecting to network services, an understanding of the data types that are suitable for assembly by the productivity tool, and an understanding of the data structures and APIs used by the disparate network services and/or data sources.

Either of these two options may generate a solution, which is rather specific to the particular instance of use or to the particular data required.

One way to make sharing of data easier is for the network service provider to build portals having accessible interfaces—HTML (hyper-text markup language) for example. While such portals are more accessible, they may be less flexible for the user to change or customize. Another drawback may be the additional expenses incurred for professional production and maintenance of such portals by the network service or data provider. Ultimately, when a particular provider is unwilling to bear such additional expenses the end user of the service or data is left with little alternative but to resort to other previously described methods.

### BRIEF DESCRIPTION OF THE DRAWINGS

The present invention is illustrated by way of example and not limitation in the figures of the accompanying drawings.

FIG. 1 illustrates one embodiment of an automated network data gathering utility.

FIG. 2 illustrates an alternative embodiment of an automated network data gathering utility.

FIG. 3 illustrates a flow diagram for one embodiment of a process to provide automated network data gathering.

FIG. 4 illustrates a flow diagram for one embodiment of an automated process to gather network data.

FIG. 5a illustrates a flow diagram for an alternative embodiment of a process to provide automated network data gathering.

FIG. 5b illustrates a flow diagram for one embodiment of a process to generate a real-time data server.

FIG. 6 illustrates a flow diagram for another alternative embodiment of a process to provide automated network data gathering.

FIG. 7 illustrates a flow diagram for another alternative embodiment of a process to provide automated network data gathering.

FIG. 8a illustrates one embodiment of a method selection dialog box to automate network data gathering.

FIG. 8b illustrates one embodiment of a data topic selection dialog box to automate network data gathering.

FIG. 8c illustrates one embodiment of a functional form to utilize automated network data gathering.

FIG. 9 illustrates one embodiment of a computing system to provide automated network data gathering.

### DETAILED DESCRIPTION

Disclosed herein is a method and apparatus for automated gathering of network data. A machine automated process generates a function for an application to access data from a network component. The function may include a network component interface to identify the types of the data and an application interface to supply the data in compatible types for the application. The network component may provide meta-data to the network component interface, so that it can identify the types of the data. The function may also include a filter to identify when data is in a compatible type and a filter to convert data to compatible types for the application. The functions generated may take numerous forms, for instance, application user-defined functions, application macros or dynamic link libraries (DLLs). The network components may also be of a number of types, for instance, Java components, Component Object Model (COM) components or other network services components supported over protocols such as the Hyper-Text Transfer Protocol (HTTP).

These and other embodiments of the present invention may be realized in accordance with the following teachings and it should be evident that various modifications and changes may be made in the following teachings without departing from the broader spirit and scope of the invention. Additionally, various well known structures, devices, circuits, etc., are not shown in detail so as to avoid obscuring the invention. The specification and drawings are, accordingly, to be regarded in an illustrative rather than restrictive sense and the invention measured only in terms of the claims.

For the purpose of the following discussion of embodiments of the present invention, illustrative terms are used. Definitions for certain such illustrative terms follow.

A computing system may be understood to mean any one of a variety of devices or systems for accessing data and/or communications. Examples include but are not limited to any combinations of one or more of the following: laptop computers, notebook computers; desktop computers, personal digital assistants, handheld computers, personal organizers; palmtop computers, pocket computers, cellular telephone/fax devices, game computers, digitizing tablet devices, electronic books, network appliances, digital audio recorder/players, multiprocessor systems, I/O system cards, daughter cards, motherboards or system-on-a-chip components.

A network component may be understood to mean any one of a variety of devices or systems for providing data and/or services. Examples include but are not limited to any combinations of one or more of the following: a database management system (DBMS), an enterprise resource planning (ERP) system, a Java component, a Perl component, a Component Object Model (COM) component, a network services component, a web services or application services system, an Open Database Connectivity (ODBC) component, a Resource Description Framework (RDF) resources, a distributed database, a search engine, a compute server, a file server, a network server, an application server, a commerce server, an audio/video server, a list server, a fax server, a mail server, an internet relay chat (IRC) server, a groupware server, a news server, a web server, a proxy server, a telnet server, or a file transfer protocol (FTP) server.

A function or functional element may be understood to mean any one of a variety of devices or systems for transferring data and/or services. Examples include but are not limited to any combinations of one or more of the following: application user-defined functions, application macros, application objects, dynamic link libraries (DLLs), real-time data servers, Java programs, Perl scripts and web page objects.

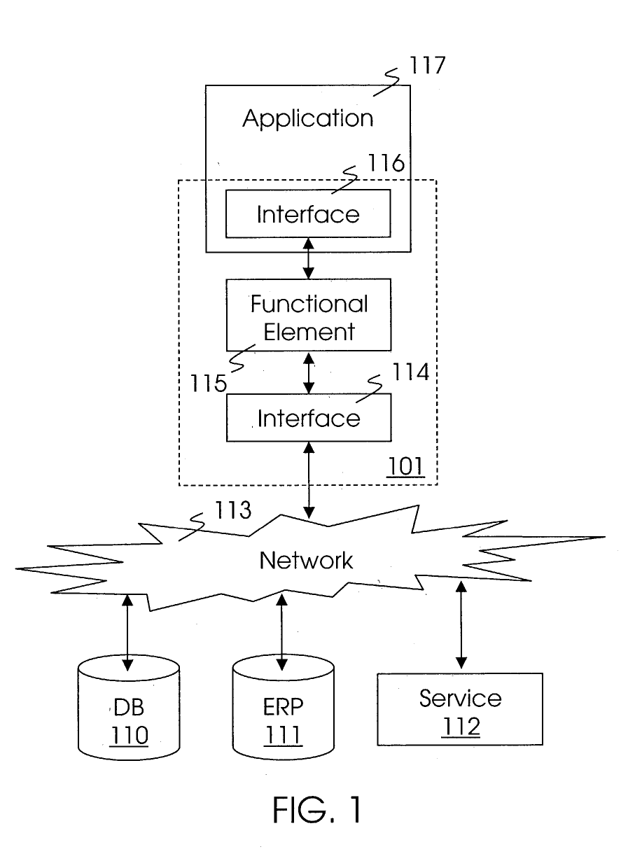

Turning now to FIG. 1, an illustration is provided of one embodiment of an automated network data gathering utility 101. Automated network data gathering utility 101 comprises interface 116 to application 117 and interface 114 to a network component via network 113. For one embodiment of an automated network data gathering utility 101, such network components may include for example, database (DB) 110, ERP system 111 and/or some other network service 112. Automated network data gathering utility 101 also comprises functional element 115 to access data from one or more network components through interface 114 and to provide the data to interface 116 for application 117. For alternative embodiments of an automated network data gathering utility 101, functional element 115 may comprise application user-defined functions, application macros, executable files and/or DLLs. For example, in one embodiment, a user may use a utility program to generate a user-defined function that retrieves and imports network data from a particular network device to a commonly used application such as Microsoft Excel.

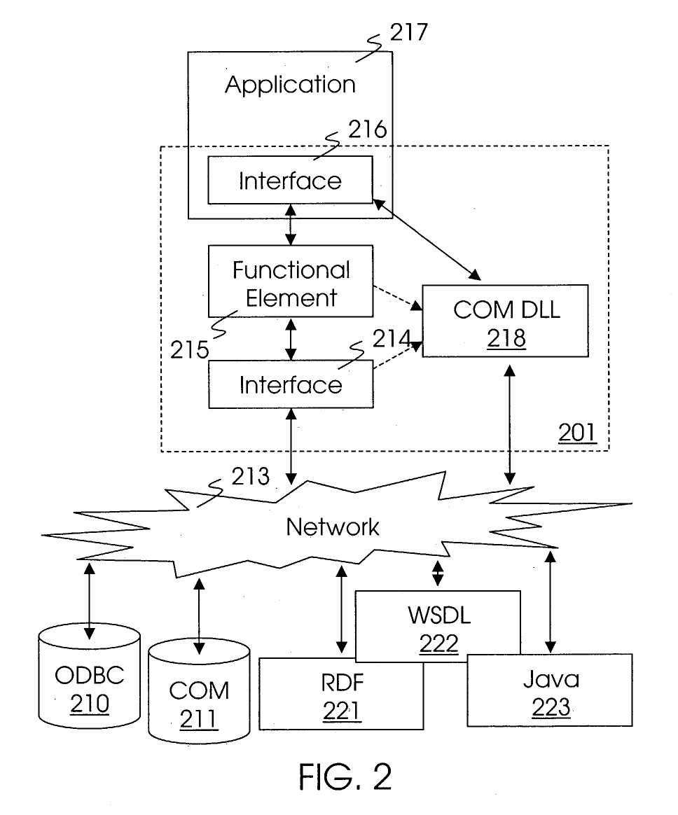

FIG. 2 illustrates, in further detail, an, alternative embodiment of an automated network data gathering utility 201. Automated network data gathering utility 201 comprises interface 216 to application 217 and interface 214 to a network component via network 213. For one embodiment of an automated network data gathering utility 201, network components may include, for example, ODBC component 210, COM component 211, RDF resources 221, Web Services Description Language (WSDL) services 222, and/or Java component 223. Automated network data gathering utility 201 also comprises functional element 215 to access data from a network component through interface 214 and to provide the data to interface 216 for application 217. Alternative embodiments of automated network data gathering utility 201 may also include DLLs, for example, COM DLL 218.

For one embodiment of an automated network data gathering utility 201, COM DLL 218 may comprise a real-time data (RTD) server, for example, as employed by a Microsoft Office application such as Excel, Word, PowerPoint, FrontPage, etc. It will be appreciated that COM DLL 218 and/or interface 216 may be created through the use of any one of a number of programming products and that prior techniques for the creation of COM DLL 218 and/or interface 216 would have required the skills of a programmer.

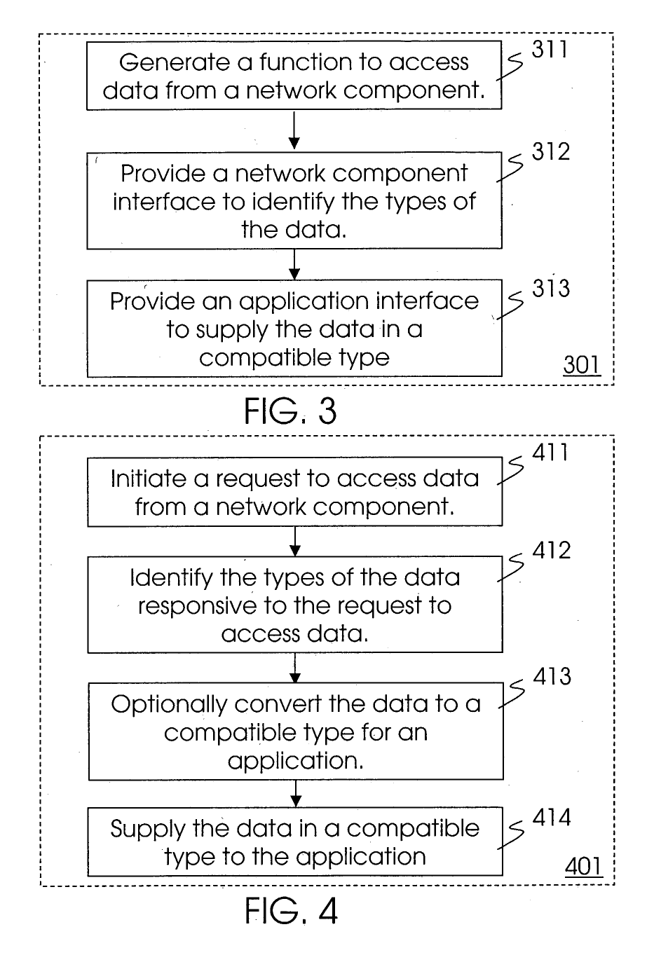

FIG. 3 illustrates a flow diagram for one embodiment of a process 301 to provide automated network data gathering. Process 301 and other processes herein disclosed are performed by processing blocks that may comprise dedicated hardware or software or firmware operation codes executable by general purpose machines or by special purpose machines or by a combination of both.

In processing block 311 a function is generated to access data from a network component. In processing block 312 a network component interface is provided to identify the types of the data accessed from the network component. In processing block 313 an application interface is provided to supply the data in types that are compatible for the application.

It will be appreciated that process 301 may provide for increased productivity and efficiency by automating data gathering from network components without requiring programming skills of an application user. For example, one embodiment of process 301 may take the form of a wizard to automate real-time data gathering in a Microsoft Office application—providing, for example, an Excel user with the capability to gather data from network services or legacy database sources.

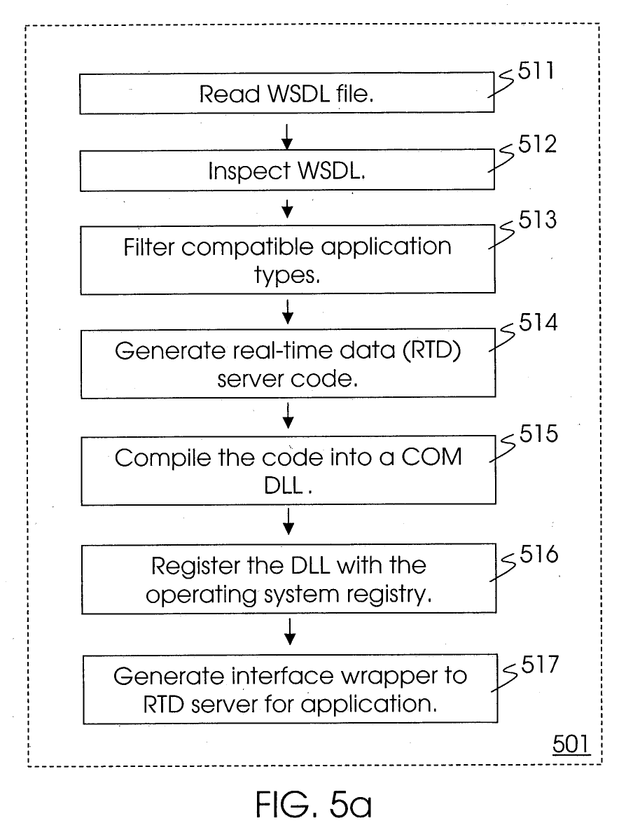

FIG. 4 illustrates a flow diagram for one embodiment of an automated process 401 to gather network data. In processing block 411 a request is initiated to access data from a network component. In processing block 412 the types of the data accessed from the network component responsive to the request are identified. In processing block 413 the data is optionally converted to compatible types for the application. In processing block 414 the data is supplied to the application in compatible types.

It will be appreciated that process 401 may be performed, for example, by automated network data gathering utility 101 or alternatively by automated network data gathering utility 201. As discussed in further detail below, it will also be appreciated that for one embodiment of process 301, the automated real-time data gathering of process 401 may be provided to an application user without requiring substantial programming skills of the application user.

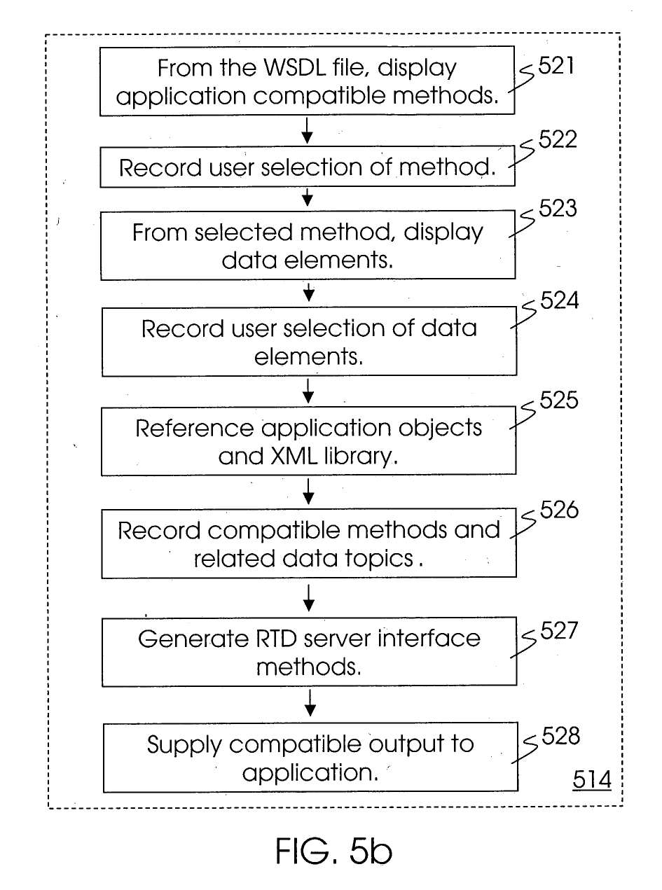

For example, FIG. 5a illustrates a flow diagram for an alternative embodiment of a process 501 to provide automated network data gathering. In processing block 511 a WSDL file is read from a network component. In processing block 512 the WSDL file is inspected, for example, to retrieve operation elements and examine their data types. In processing block 513 an application interface filters the data types compatible for the application—passing through compatible data types and optionally converting incompatible data types as desired. In processing block 514 code for a RTD server is generated. In processing block 515 the RTD server code is compiled into a COM DLL. In processing block 516, the DLL is registered with the operating system registry. For one embodiment of process 501, the DLL is registered with a Windows operating system registry through an Automation Interface by using an installer object (details may be found at the HTTP web page, msdn.microsoft.com/library/en-us/msi/setup/installer_object.asp). Finally, in processing block 517, an interface wrapper to the RTD server is generated for the application. For example, in one embodiment, visual basic code may be generated for a user-defined function to make the RTD server data available in an Excel spreadsheet without requiring substantial programming skills of the user.

FIG. 5b illustrates a flow diagram for one embodiment of processing block 514 to generate code for an RTD server. In processing block 521 application compatible methods are displayed from the WSDL file to the user for selection. In processing block 522 the user's selection of a method is recorded. In processing block 523 data elements are displayed from the selected method to the user for selection. In processing block 524 the user's selection of data elements is recorded. In processing block 525 the application objects and Extensible Markup Language (XML) library are referenced. In processing block 526 compatible records and related data topics are recorded and maintained. In processing block 527 the RTD server interface methods are generated—for example, ConnectData and RefreshData making Simple Object Access Protocol (SOAP) calls to the user selected method of the WSDL network service or application service. In processing block 528 compatible output is supplied to the application.

As an example, Visual Basic code that may be generated for an Excel, RTD server follows:

```
Option Explicit
Implements Excel.IrtdServer
Private Function IrtdServer_ConnectData(ByVal TopicID As Long, _{—}
    String( ) As Variant, GetNewValues As Boolean) _{—}
    As Variant
// Code to make a SOAP call to the Web Service to get the real time data
value.
// Parse the received XML message to retrieve the RTD value
    IrtdServer_ConnectData = objTopic.TopicValue
End Function
Private Sub IrtdServer_DisconnectData _{—}
    (ByVal TopicID As Long)
End Sub
Private Function IrtdServer_Heartbeat( ) As Long
    IrtdServer_Heartbeat = SUCCESS
End Function
Private Function IrtdServer_RefreshData _{—}
    (TopicCount As Long) As Variant( )
// Code to make a SOAP call to the Web Service to get the real time data
value.
// Parse the received XML message to retrieve the RTD value
IrtdServer_RefreshData = avarUpdates
End Function
Private Function IrtdServer_ServerStart _{—}
    (ByVal CallbackObject As Excel.IRTDUpdateEvent) _{—}
    As Long
    IrtdServer_ServerStart = SUCCESS
End Function
Private Sub IrtdServer_ServerTerminate( )
    Dim objTopic As Ctopic
    Set objTopic = Nothing
    Call KillTimer (hwnd:=0, nIDEvent:=glngTimerID)
End Sub
```

It will be appreciated that the examples illustrated in FIGS. 5a and 5b and other processes herein disclosed may be utilized through numerous combinations of platforms, operating systems or programming languages. It will also be appreciated that, while the examples illustrated in FIGS. 5a and 5b and in other processes herein disclosed may generate code for an RTD server that accesses a network or application service having a WSDL description of the available services, using XML tagged data formats, and/or receiving SOAP calls to transfer data via port 80, the Hyper-Text Transfer Protocol (HTTP); alternative embodiments of a process to provide automated network data gathering may conveniently select to use other combinations of standards, protocols and languages for accessing network data and services. For example, although SOAP uses a Document Object Model (DOM) based on XML, one based on the Hyper-Text Markup Language (HTML) could also be used. Even though SOAP transfers data using HTTP, another transfer protocol, port 21, for example, the FTP could also be used. Although a WSDL description of the available services may be used to filter data types and generate a RTD server, an e-business XML (ebXML) Collaboration Protocol Profile and Agreement (CPPA) description, COM queries, ODBC Structured Query Language (SQL) queries, or Java reflection could also be used.

In particular, especially as organizations such as the World Wide Web Consortium (W3C) establishes new standards for DOMs, RDFs and the like, and as companies collaborate or compete to establish new defacto standards; practitioners may make modifications to examples herein disclosed in accordance with newly established WC3 standards and/or newly established defacto standards without departing from the broader principles of the present invention.

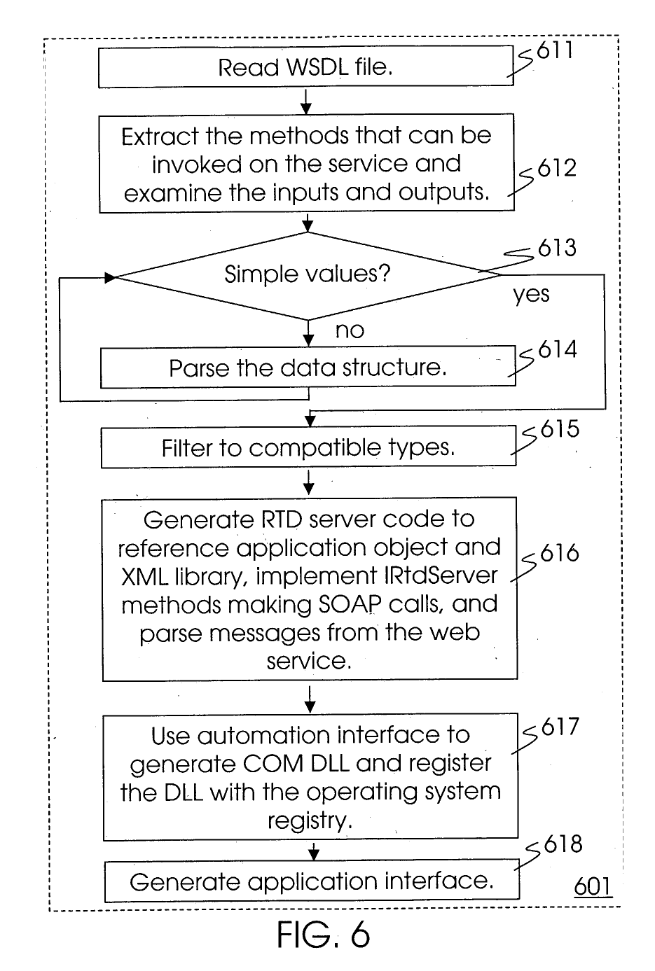

FIG. 6 illustrates a flow diagram for another alternative embodiment of a process 601 to provide automated network data gathering. In processing block 611 a WSDL file is read from a network component. In processing block 612 methods that can be invoked on the services are extracted and the inputs and outputs are examined. In processing block 613 a test is performed to identify whether the input data and output data types are simple values. If not, the data structures of the inputs and outputs are parsed in processing block 614 and processing returns to processing block 613. Otherwise, processing continues in processing block 615 where the data is filtered to compatible types—passing through compatible data types and optionally converting incompatible data types as desired. In processing block 616 code for a RTD server is generated to reference application objects and XML libraries, implement IRtdServer interface methods making SOAP calls, and parse messages from the web service. In processing block 617, using the automation interface, the RTD server code is compiled into a COM DLL and registered with the operating system registry. Finally, in processing block 618, an interface is generated for the application. For example, in one embodiment, a user-defined function is generated in a spreadsheet or a macro is generated in a report document to make data available without requiring substantial programming skills of the user.

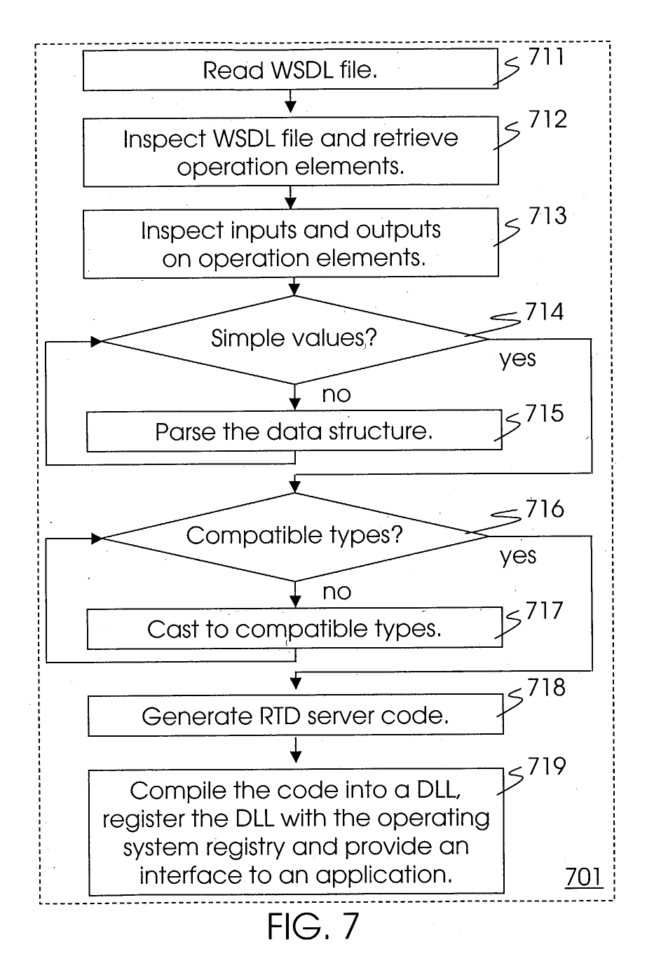

FIG. 7 illustrates a flow diagram for another alternative embodiment of a process to provide automated network data gathering. In processing block 711 a WSDL file is read from a network component. In processing block 712 the WSDL file is inspected and operation elements are retrieved. In processing block 713 the input and output data of operation elements are inspected. In processing block 714 a test is performed to identify whether the input data and output data types are simple values. If not, the data structures of the inputs and outputs are parsed in processing block 715 and processing returns to processing block 714. Otherwise, processing continues in processing block 716 where a test is performed to identify whether the input data and output data are of compatible types. If not, in processing block 717 the data of the inputs and outputs are optionally converted to compatible data types as desired. Otherwise compatible data types may be passed through and processing continues in processing block 718 where code for a RTD server is generated. In processing block 719, using the automation interface, the RTD server code is compiled into a DLL and registered with the operating system registry. An interface is provided to an application to make data available without requiring substantial programming skills of the user.

As an example, pseudo-code to generate an automated network data gathering utility follows:

Code generator component: Read WSDL file, invoke Filter component
and pass the WSDL file to the filter component.
Filter component:

| | |
|---|---|
| a. | Inspect the WSDL file and retrieve all the <operation> elements. |
| b. | Inspect both the <input> and <output> elements on the <operation> |
| | elements. |
| c. | If (<input> = simple type and <input> = compatible data types) |
| | do nothing. |
| d. | If (<input>= simple type and <input> != compatible data types) |
| | cast the input value to text. |
| e. | If (<input> = structure) repeat steps c and d for each element in |
| | the structure. |
| f. | If the operation takes more than one input parameters, then |

| | |
|---|---|
| I. | Prompt user to enter multiple values in the spreadsheet |
| | cell before invoking the service. |
| II. | Generate code that packages the values entered as |
| | structure or multiple parameters to the operation |
| | depending on the number of input parameters and data |
| | type of the parameters of the operation. The data may be |
| | packaged from left to right, e.g.: |

<operation> Trackpackage

<input>

<packageDetails>

<dateShipped>
<timeShipped>

</packageDetails>
<personWhoShipped>
</personWhoShipped>

</input>
<output>

<packageStatus>
</packageStatus>
<dateReceived>
</dateReceived>
<personWhoReceived>
</personWhoReceived>

</output>

</operation>

| | |
|---|---|
| g. | Perform steps c, d, and e for the <output> elements (instead of |
| | the <input> elements) on the <operation> elements. |
| h. | If the output is a single value of simple type, then generate |
| | code to cast the output value to text as required and return |
| | the value to the application. |
| i. | If the output is a structure, then generate code according to the |
| | manner selected for output to be displayed by the application: |

| | |
|---|---|
| I. | User can select an element of interest through a popup |
| | dialog box shown by the filter component during code |
| | generation. |
| II. | User can select an element of interest at runtime by |
| | entering the element name as the last value when |
| | invoking the method. |

In the pseudo-code example given above, the operation, Trackpackage, takes two inputs. The first input, packageDetails, is a structure of two elements, dateShipped and timeShipped, the second input, personWhoShipped, is a simple type. When the web service operation is invoked, for example from an Excel spreadsheet, the three input arguments may be entered in a cell, the first two may be packaged as input one, packageDetails, and the third may be input two, personWhoShipped. Alternatively, the three input arguments may be entered in two (or three) cells and both (or all three) cells may be entered as arguments to an RTD function.

It will be appreciated that, the above example, makes reference to an Excel spreadsheet, but that other applications are equally suitable for generating automated network data gathering utilities. There is a feature of Excel that allows for a capability being provided to a user to generate an automated network data gathering utility. That feature is the user-defined function (i.e., functions similar to the native functions such as SUM and AVERAGE). User-defined functions permit users to call external programs from within the application. Therefore, any similar features found in Excel or other applications may also be used to provide for generating automated network data gathering utilities. For example, the user-defined macros of Word, PowerPoint or other applications provide sufficiently similar features for generating automated network data gathering utilities to access network component data and/or services. A wizard, for example, can be activated to generate the wrappers to the network services and also to generate the Visual Basic (or other suitable source) code required to define the macros and insert them into a document, making them available to the user without requiring programming skills.

Therefore, while the above and further illustrative examples involving Excel spreadsheets and Visual Basic may be used, it will be appreciated that the methods herein disclosed or methods substantially similar to those herein disclosed may be implemented in one or more of many programming languages (including but not limited to C, C++, Java, Perl, Visual Basic, FORTRAN, Visual C++, Visual J++); applications (including but not limited to Microsoft Excel, Word, PowerPoint, FrontPage, Outlook and Access; Lotus 123 and Notes; Corel WordPerfect and Quattro Pro; X Engineering Software Systems NExS; or Apple AppleWorks); and/or systems (including but not limited to Windows, Linux, Mac OS X, or UNIX) for performing automated data gathering using networked computing devices.

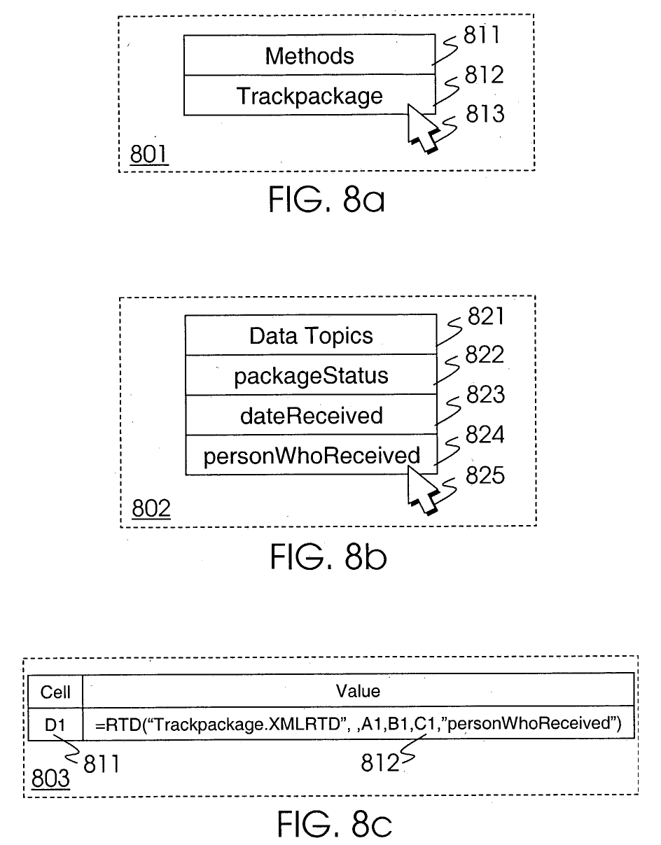

Turning now to FIG. 8a, an illustration is provided of one embodiment of a method-selection dialog box 801 to automate network data gathering. Upon examination of a metadata description, for example a WSDL file, methods that can be invoked are extracted and may be displayed in method selection dialog box 801. For example, a list of compatible methods is indicated by title 811 and an Excel compatible method, Trackpackage, is listed in selection box 812. A user may select to automate network data gathering for the Trackpackage method by choosing selection box 812, for example, by clicking a mouse button while cursor 813 is positioned over selection box 812. When the user selects a method to invoke, the outputs of the method may be displayed in a data topic selection dialog box.

FIG. 8b illustrates one embodiment of a data topic selection dialog box 802 to automate network data gathering. The inputs and outputs of the selected method are examined. Structures are parsed and available data elements may be displayed. For example, a list of available data topics is indicated by title 821 and the data elements that Excel can use as RTD topics, packageStatus, dateReceived, and person WhoReceived are listed in selection boxes 822-824 respectively. A user may select to automate network data gathering for the personWhoReceived data topic by choosing selection box 824, for example, by clicking a mouse button while cursor 825 is positioned over selection box 824. When the user selects a data topic, a RTD server DLL may be generated and registered in the operating system registry.

FIG. 8c illustrates one embodiment of a functional form 803 to utilize automated network data gathering. Assuming that the operation, Trackpackage, returns a structure, {packagestatus, dateReceived, and personWhoReceived} as output. If the user is interested in the personWhoReceived, the user may indicate that choice during code generation as illustrated in FIG. 8b, or enter “personWhoReceived” as the last element when invoking the method, for example from an Excel spreadsheet, using =RTD(“Trackpackage.XMLRTD”, , A1, B1, C1, “personWhoReceived”) as shown in value box 812. The output structure returned by the method is parsed by the generated code to extract the value of person who received the package and pass it to the application in cell D1, as shown in cell box 811.

Accordingly, the RTD add-in functions, macros, etc. may be generated and installed or inserted into the documents, making them available to the user without requiring programming skills.

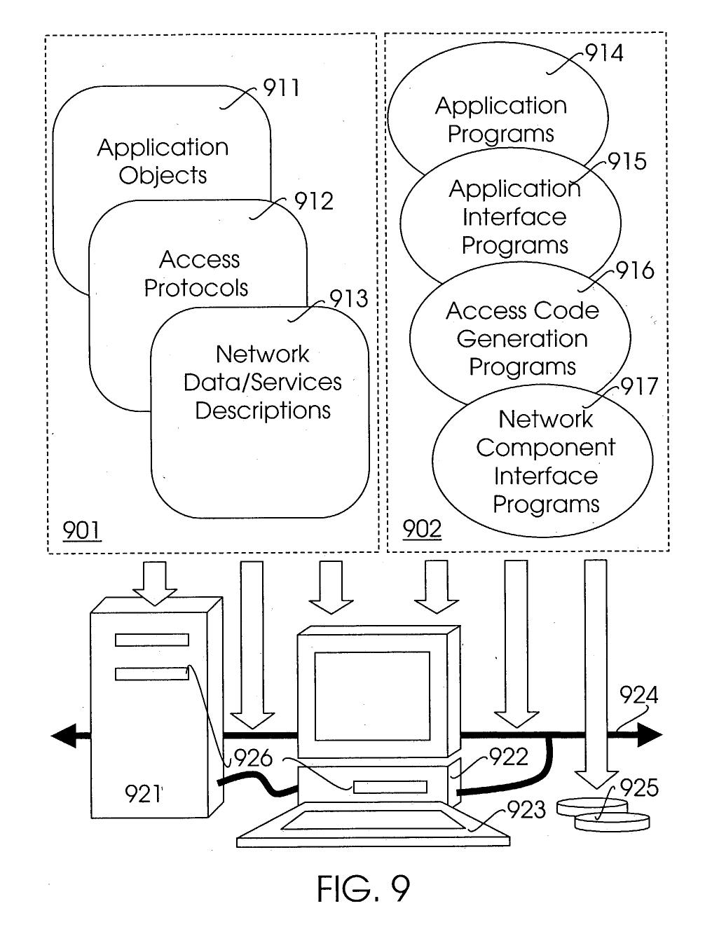

FIG. 9 illustrates one embodiment of a computing system to provide automated network data gathering. Computer system 922 is connectable with various storage, transmission and I/O devices to receive data structures and programmed methods. Representative data structures 901 may include but are not limited to application objects 911, access protocols 912, and network data/services descriptions 913. Representative programmed methods 902 may include but are not limited to application programs 914, application interface programs 915, access generation programs 916, and network component interface programs 917. Components of either or both of the data structures and programmed methods may be stored or transmitted on devices such as removable storage disks 925, which may be accessed through an access device 926 in computer system 922 or in a storage serving system 921. Storage serving system 921 or computer system 922 may also include other removable storage devices or non-removable storage devices suitable for storing or transmitting data structures 901 or programmed methods 902. Component data structures and programmed methods may also be stored or transmitted on devices such as network 924 for access by computer system 922 or entered by users through I/O device 923. It will be appreciated that the complexity, capabilities, and physical forms of such computing systems improves and changes rapidly, and therefore understood that the computing system illustrated is by way of example and not limitation.

The above description is intended to illustrate preferred embodiments of the present invention. From the discussion above it should also be apparent that especially in such an area of technology, where growth is fast and further advancements are not easily foreseen, the invention may be modified in arrangement and detail by those skilled in the art without departing from the principles of the present invention within the scope of the accompanying claims and their equivalents.

What is claimed is:

1. A machine automated method comprising:
generating a function for an application to access a first data from a first network component;
providing a network component interface to identify a first type of the first data; and
providing an application interface to supply the first data in a compatible type for the application.

2. The machine automated method of claim 1 further comprising:
providing a filter to identify when the compatible type for the application is the first type.

3. The machine automated method of claim 1 further comprising:
providing a filter to convert the first data from the first type to the compatible type for the application.

4. The machine automated method of claim 1 wherein the first network component provides meta-data to identify said first type.

5. The machine automated method of claim 4 wherein the first network component is a Java component.

6. The machine automated method of claim 4 wherein the first network component is a COM component.

7. The machine automated method of claim 4 wherein the first network component is a network services component.

8. An article of manufacture comprising
a machine-accessible medium including data that, when accessed by one or more machines, causes the one or more machines to automate the method of claim 4.

9. The machine automated method of claim 1 wherein the function comprises an application user-defined function.

10. The machine automated method of claim 1 wherein the function comprises an application macro.

11. The machine automated method of claim 11 wherein the function comprises a real-time data server.

12. The machine automated method of claim 11 further comprising:
compiling the real-time data server into a DLL; and
deploying the DLL.

13. An article of manufacture comprising
a machine-accessible medium including data that, when accessed by one or more machines, causes the one or more machines to automate the method of claim 11.

14. An article of manufacture comprising
a machine-accessible medium including data that, when accessed by one or more machines, causes the one or more machines to automate the method of claim 1.

15. A software utility on a machine-accessible medium comprising:
a functional element to access data from a first network component for an application, said data including a first data;
a network component interface, responsive to a first request for access to the first data, to automatically identify a first type of the first data; and
an application interface to automatically supply the first data in a first compatible type for the application.

16. The software utility of claim 15 further comprising:
a code generator to access a meta-data from the first network component identifying the first type of the first data; and
a filter component coupled with the code generator to inspect the meta-data and inform the code generator, responsive to the meta-data, to generate code for the functional element.

17. The software utility of claim 15, said first data further including a second data;
said network component interface, responsive to the first request for access to the first data, to automatically identify a second type of the second data; and
said application interface to automatically supply the second data in a second compatible type for the application.

18. An article of manufacture comprising
a machine-accessible medium including data that, when accessed by one or more machines, causes the one or more machines to generate the software utility of claim 15.

19. The article of manufacture of claim 18 comprising a software wizard.

20. An article of manufacture comprising:
a machine-accessible medium including data that, when accessed by a machine, cause the machine to:
generate a function for an application to access a first data from a first network component responsive to a user selection of the first data;
provide a network component interface to identify a first type of the first data; and
provide an application interface to supply the first data in a compatible type for the application.

21. The article of manufacture of claim 20 wherein the function comprises an application macro.

22. The article of manufacture of claim 20 wherein the function comprises a user-defined function.

23. The article of manufacture of claim 20 wherein the function comprises a real-time data server.

24. The article of manufacture of claim 23 including data that when accessed by the machine, cause the machine to:
generate the real-time data server for the function to access the first data from the first network component; and
register the real-time data server with an operating system registry.

25. A computing system comprising:
an addressable memory;
at least one processor:
a machine-accessible medium including data that, when accessed by the processor, causes the system to:
store the data in the addressable memory and access the data to generate an automated network data gathering utility;
generate a functional element for the automated network data gathering utility to access a first data from a first network component responsive to a user selection of said first data;
provide a network component interface for the automated network data gathering utility to identify a first type of the first data; and
provide an application interface for the automated network data gathering utility to supply the first data in a compatible type for an application.

26. The computing system of claim 25 wherein the machine-accessible medium includes data that, when accessed by the processor, further causes the system to:
generate the real-time data add-in for the for the automated network data gathering utility to access the first data from the first network component; and
register the real-time data add-in with an operating system registry.

27. The computing system of claim 26 wherein the operating system registry is a windowing operating system registry.

28. The computing system of claim 27 wherein the application is a spreadsheet application.

29. The computing system of claim 27 wherein the application is a word processing application.

30. The computing system of claim 27 wherein the application is a web page editing application.
